(19) United States
(12) Patent Application Publication
(10) Pub. No.: US 2013/0101276 A1
(43) Pub. Date: Apr. 25, 2013

(54) SINGLE AXIS GIMBAL OPTICAL STABILIZATION SYSTEM

(71) Applicants: Sean D. Keller, Tucson, AZ (US); Quenten E. Duden, Tucson, AZ (US)

(72) Inventors: Sean D. Keller, Tucson, AZ (US); Quenten E. Duden, Tucson, AZ (US)

(73) Assignee: RAYTHEON COMPANY, Waltham, MA (US)

(21) Appl. No.: 13/278,393

(22) Filed: Oct. 21, 2011

(51) Int. Cl. G03B 5/00; G02B 27/64

(52) U.S. Cl. 396/55; 359/557

(57) ABSTRACT

An optical stabilization system includes a camera, risley prism, a sensor, and a motor. The camera has a field of view and is configured to receive incoming light to image a target. The risley prism is optically coupled to the camera and includes a first wedge prism and a second wedge prism each configured to rotate about a first axis and configured to change an angle of incidence of the incoming light at the camera. The sensor is configured to sense movement of the optical stabilization system and to provide movement data. The motor is coupled to the sensor and to the risley prism and is configured to rotate at least one of the first and second wedge prisms about the first axis to change the angle of the incoming light in response to the movement data to maintain the target within the field of view of the camera.

### BACKGROUND

Cameras are often mounted to airplanes to capture images on the ground. However, accurately capturing images of target locations from an airplane can be difficult, especially when the airplane encounters turbulence or other unpredictable movement. One conventional solution to this problem is to mount the camera to a platform in a set of gimbals which allow the camera three axes of rotation, and to rotate the camera in response to airplane movement in order to maintain the camera focus on the target location.

### SUMMARY

Existing aircraft-based imaging systems have several limitations. For example, imaging systems with a three axis gimbal are expensive and bulky, and may not be aerodynamic when mounted on an aircraft.

Aspects and embodiments are directed to methods and apparatus for providing an optical stabilization system for use on a mobile platform, which includes a one axis rotation of a risley prism. The risley prism may include two wedge prisms which can be independently rotated to bend light. According to one embodiment, using a one axis gimbal imaging system with a risley prism mitigates several disadvantages associated with conventional systems and provides a cost effective, aerodynamic imaging system, as discussed further below.

According to one aspect, an optical stabilization system includes a camera, a risley prism, a sensor, and a motor. The camera has a field of view and is configured to receive incoming light to image a target. The risley prism is optically coupled to the camera and includes a first wedge prism and a second wedge prism each configured to rotate about a first axis and configured to change an angle of incidence of the incoming light at the camera. The sensor is configured to sense movement of the optical stabilization system and to provide movement data. The motor is coupled to the sensor and to the risley prism and is configured to rotate at least one of the first and second wedge prisms about the first axis to change the angle of the incoming light in response to the movement data to maintain the target within the field of view of the camera.

According to one embodiment the optical stabilization system also includes a controller coupled to the sensor and to the motor and configured to receive the movement data from the sensor and, in response to the movement data, direct the motor to rotate the first and second wedge prisms. The controller may also be configured to correlate images from the camera with the location coordinates of the optical stabilization system to determine locations on the earth corresponding to the images.

In one embodiment, the first and second wedge prisms are positioned between the incoming light and the camera. In another embodiment, the optical stabilization system also includes a mirror positioned adjacent to the first wedge prism configured to direct the incoming light into the first wedge prism.

According to one embodiment, the sensor is an inertial measurement unit. In another embodiment, the optical stabilization system is mounted on a mobile platform, and the sensor is configured to calculate angles of movement of the mobile platform with respect to the earth. The movement data may include the angles of movement. In a further embodiment, the system is mounted on a mobile platform, and the sensor is configured to calculate the pitch, roll, and yaw of the mobile platform.

In one embodiment, the optical stabilization system also includes a global positioning unit coupled to the sensor and configured to determine location coordinates of the optical stabilization system. The optical stabilization system may be installed in an aircraft. In another embodiment, the first and second wedge prisms together comprise a risley prism.

According to one aspect, a method of stabilizing a field of view of an optical imaging system mounted on an aircraft, includes directing a field of view of the optical imaging system toward a ground-based target, detecting motion of the aircraft and providing corresponding angular movement data, and refracting incident light on optical imaging system by rotating at least one of a risley prism responsive to the angular movement data to maintain the target within the field of view of the optical imaging system. In one embodiment, detecting motion includes sensing pitch, roll and yaw of the aircraft.

In one embodiment, the method also includes determining location coordinates of the optical imaging system with a global positioning unit, and correlating images captured with the optical imaging system with the location coordinates. In another embodiment, rotating the at least one of the wedge prisms in the risley prism includes actuating a motor coupled to the wedge prism to rotate the wedge prism.

Still other aspects, embodiments, and advantages of these exemplary aspects and embodiments, are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE FIGURES

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures and description. In the figures, each identical or nearly identical component that is illustrated in various figures is represented by a like numeral. For purposes of clarity, not every component may be labeled in every figure. In the figures:

FIG. 1A is a schematic diagram of an airplane and the field of view of an imaging system mounted underneath the airplane, according to aspects of the invention;

FIG. 1B is a schematic diagram of an airplane and the fields of view of an imaging system before and after correction, according to aspects of the invention;

FIGS. 2A-2C are schematic diagrams of a risley prism and a beam of light;

FIG. 3 is a schematic diagram of a risley prism;

FIG. 4 is a block diagram showing elements of an optical stabilization system according to an embodiment of the invention;

FIG. 5 is a schematic diagram showing a side view of a system for rotating first and second wedge prisms about an axis;

FIG. 6 is a flow chart showing a method of stabilizing an optical imaging system in an aircraft, according to an embodiment of the invention;

FIG. 7A is a schematic diagram showing the parts of an imaging system including a one axis risley prism gimbal according to aspects of the invention;

FIG. 7B is a schematic diagram of an assembled imaging system including a one axis risley prism gimbal according to aspects of the invention;

FIG. 8 is a graph showing the resolution of the imaging system in line pairs per inch at various altitudes according to aspects of the invention;

FIG. 9A is a graph showing the error correction results at different roll angles according to aspects of the invention;

FIG. 9B is a graph showing the error correction results at different pitch angles according to aspects of the invention;

FIG. 10 is a graph showing correction rate at various degrees of rotation according to aspects of the invention; and

FIG. 11 is graph showing the prism dispersion comparison on the ground at various altitudes for two different prism materials according to aspects of the invention.

### DETAILED DESCRIPTION

As discussed above, an imaging system on a three axis gimbal suffers from several disadvantages, including non-aerodynamic construction and high cost. In a typical gimbal-based imaging system, a camera is mounted on the mobile gimbal platform, and the gimbal platform is moved to change the camera's field of view. On an aircraft, the gimbal platform is moved to maintain the camera's field of view on the ground, aligned with the horizon. However, a typical gimbal-based imaging system is not aerodynamically designed, and mounting the camera on a gimbal platform underneath an aircraft creates drag on the aircraft. Furthermore, a typical gimbal-based imaging system, configured to move the camera about three axes of rotation, is expensive.

Thus, there is a need for a more aerodynamic and cost-effective optical stabilization system for adjusting the field of view of an imaging system on an unstable platform. Accordingly, aspects and embodiments are directed to an optical stabilization system with a single axis gimbal comprised of multiple thin prisms for angling incoming light and adjusting the field of view of a camera. In one example, the single axis gimbal includes a risley prism (also referred to as a risley prism pair), including two wedge prisms. As discussed in more detail below, in one embodiment, the thin wedge prisms are positioned adjacent to each other and rotated around a single axis to angle the incoming light. The prisms may each be rotated in opposite directions around the axis, or they may both be rotated in the same direction around the axis. In one example, a sensor, such as an Inertial Measurement Unit (IMU) detects aircraft movement, and a controller rotates the wedge prisms in response to IMU measurements to angle the incoming light and maintain the field of view of the camera. In one embodiment, the optical stabilization system can be mounted in the fuselage of an aircraft, with a fold mirror angling light into the prisms, which further bend the light and alter the line of sight of the camera. Positioning the optical stabilization system in the fuselage of an aircraft decreases the aerodynamic impact of the system. Furthermore, the optical stabilization system described herein would be substantially less expensive than a conventional three axis gimbal optical stabilization system.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, and left and right are intended for convenience of description, not to limit the present systems and methods or their components to any one positional or spatial orientation.

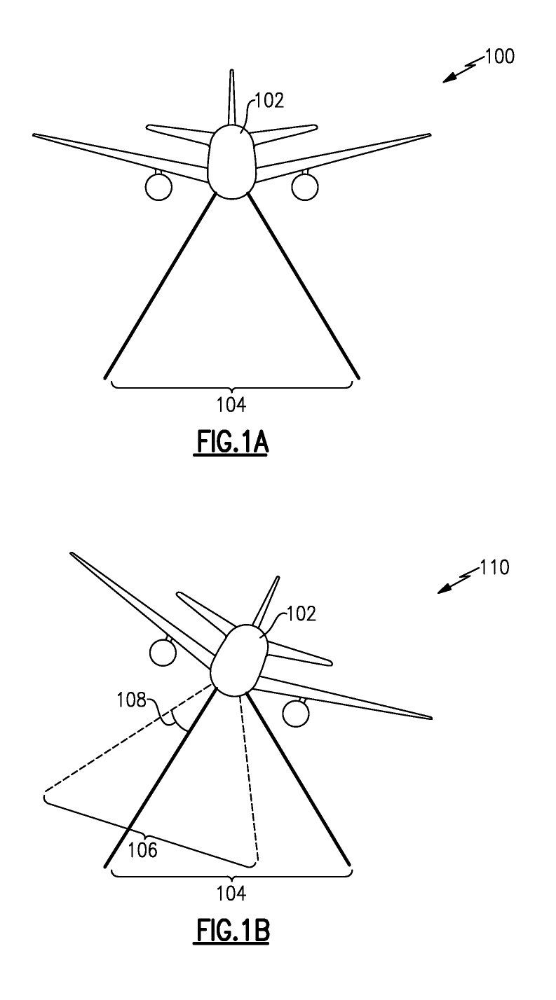

Referring to FIG. 1A, there is illustrated a schematic diagram 100 of an airplane 102 and the field of view 104 of an imaging system extending down toward the ground from the airplane, according to an embodiment of the invention. The airplane 102 in FIG. 1A is shown to be level with the horizon, and thus, the field of view is centered on the ground. FIG. 1B is a schematic diagram 110 of the airplane 102 tilted clockwise with a roll angle 108. If the imaging system mounted underneath the airplane 102 was static, the field of view of the camera would change with the tilt of the airplane 102, as illustrated by the dashed lines showing the uncorrected field of view 106. Using an optical stabilization system as discussed in greater detail below, the field of view of the imaging system is corrected to be directed on the ground perpendicular to the horizon, allowing the imaging system to record images of the ground beneath the airplane 102. The corrected field of view 104 of the imaging system is shown by the solid lines.

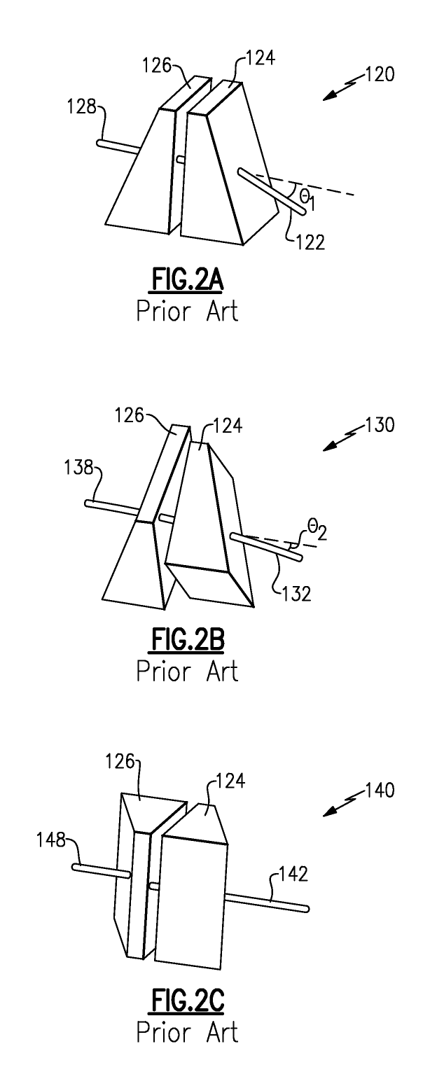

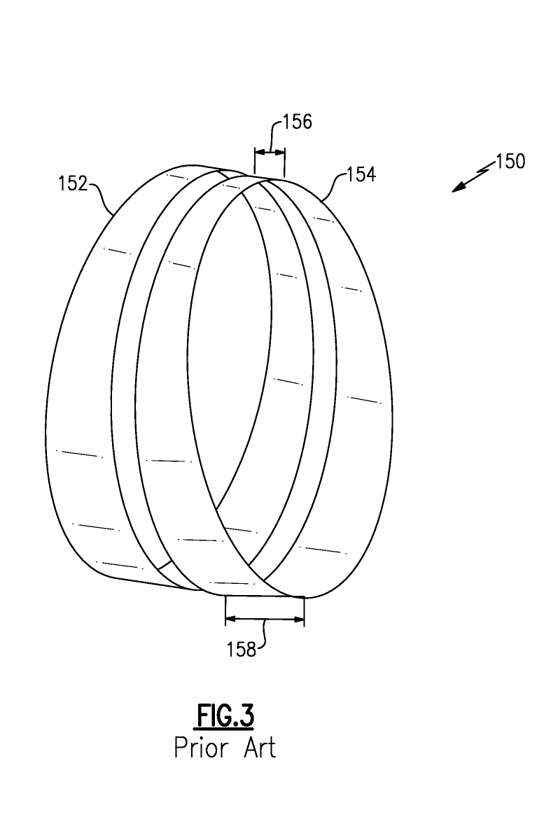

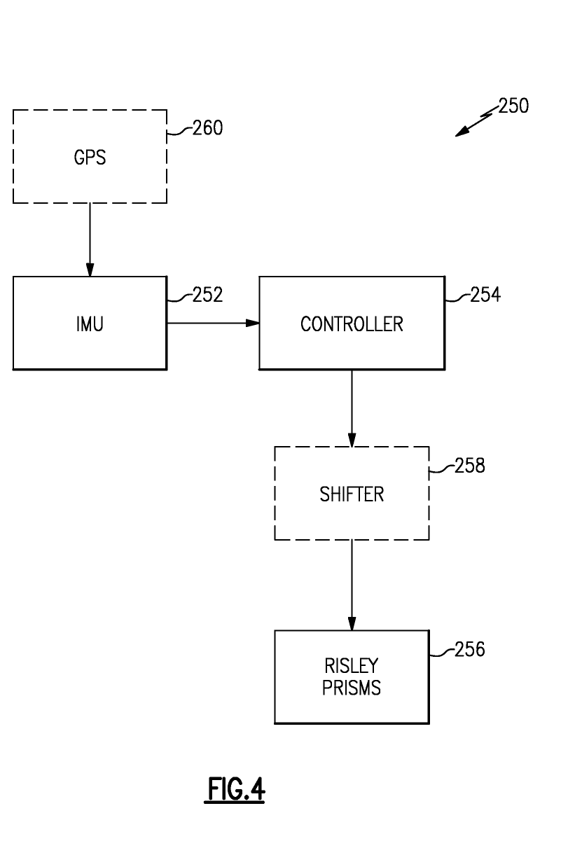

According to one embodiment, the optical stabilization system includes a single axis gimbal that rotates two prisms around a single axis to change the angle of incoming light and adjust the field of view of a camera. In one example, these prisms form a risley prism including two wedge prisms that can rotate with respect to one another. FIGS. 2A-2C show several examples of different orientations of the prisms and refracted beams of light. The changes to the angles of the light beams is described below using the horizontal coordinate system, in which elevation (or altitude) is the angle between the object and the observer's local horizon, and azimuth is the angle of the object around the horizon, measured from the central axis of the camera's field of view.

FIG. 2A is a schematic diagram 120 of a risley prism, including first 124 and second 126 wedge prisms, an incoming beam of light 122 and a transmitted beam of light 128, according to one embodiment. The incoming beam of light 122 enters the first prism 124, which refracts the beam of light, altering its angle. The refracted beam of light enters the second prism 126 where it is refracted a second time, further altering its angle, and transmitted as the transmitted beam 128. According to one example, the transmitted beam of light 128 is aligned with the center axis of the field of view of a camera, and the wedge prisms 124 and 126 are rotated such that the beam of light 122 entering from a selected angle θ₁ is bent to align with the center axis. Thus, the wedge prisms 124 and 126 change the elevation (or altitude) of the camera's line of sight by the angle θ₁. The wedge prisms 124 and 126 may be rotated together about the central axis to change the azimuth of the camera's line of sight while maintaining the elevation angle θ₁ in any direction. According to one feature, while other beams of light may enter the wedge prisms 124 and 126 and be refracted, incoming light at the selected angle θ₁ will be refracted to produce a transmitted beam of light 138 aligned with the center axis of the camera line of sight. According to one embodiment, the maximum change in the angle of the incoming beam of light 122 is created when the wedge prisms are positioned as shown in FIG. 2A, with the thin side of each prism aligned in parallel and the thick side of each prism aligned in parallel.

FIG. 2B is a schematic diagram 130 of the first 124 and second 126 wedge prisms, an incoming beam of light 132 and a transmitted beam of light 138, according to one embodiment. In FIG. 2B, the first 124 and second 126 wedge prisms are rotated in opposite directions around a central axis. According to one example, the transmitted beam of light 138 is aligned with the center axis of the field of view of a camera, and the wedge prisms 124 and 126 are rotated to select the beam of light 132 entering from a selected elevation angle θ₂. Different relative positions of the first 124 and second 126 wedge prisms may be used to select light entering from various elevation and azimuth angles.

FIG. 2C is a schematic diagram 140 of the first 124 and second 126 wedge prisms, an incoming beam of light 142 and a transmitted beam of light 148, according to one embodiment. In FIG. 2C, the first 124 and second 126 wedge prisms are rotated around a central axis such that the thin side of the first wedge prism 124 is aligned with the thick side of the second wedge prism 126, and the thin side of the second wedge prism 126 is aligned with the thick side of the first wedge prism 124. In this alignment, the incoming beam of light 142 has the same angle as the transmitted beam of light 148. Although the first prism 124 refracts the incoming beam of light 124, changing its angle, the second prism 126 also refracts the beam of light and changes the angle again such that there is no net change in angle. In this manner, when positioned as shown in FIG. 2C, the wedge prisms 124 and 126 in combination do not change the angle of the incoming beam of light 122.

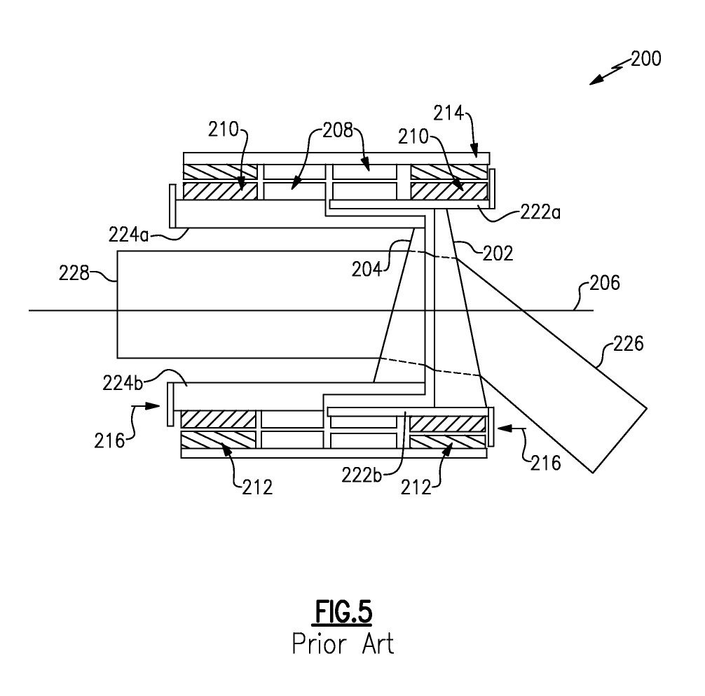

Although FIGS. 2A-2C show triangular-shaped wedge prisms 124 and 126, in other embodiments, the wedge prisms may have other shapes while still being substantially wedge-shaped prisms and forming a risley prism. In one example, the first 124 and second 126 wedge prisms may be different sizes. In another example, as shown in FIG. 3 the wedge prisms 152 and 154 are cylindrical wedges. As shown with respect to the wedge prism 154, the cylindrical wedge has a narrow width 156 on one side and a large width 158 on the opposite side, and the width of the cylinder progressively increases from the narrow side to the large side. In various embodiments, the wedge prisms 152 and 154 may be the same size or the prisms 152 and 154 may be different sizes. In other embodiments, the prisms may have numerous different shapes and sizes provided that each prism varies in at least one dimension and the prisms are rotatable with respect to each other.

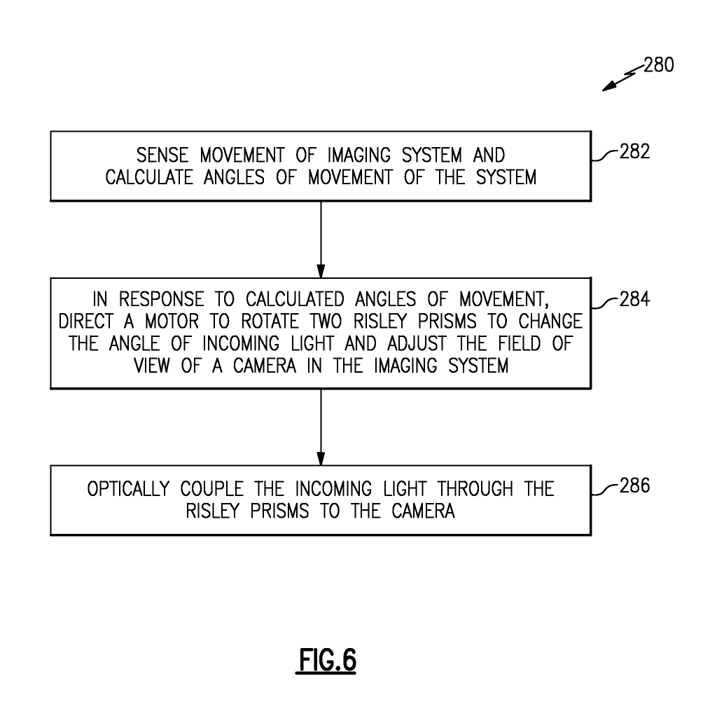

An optical stabilization system including a risley prism also includes several other elements, such as a sensor to sense movement of the system and a controller to control movement of the prisms. FIG. 4 is a block diagram 250 of elements of an optical stabilization system according to one embodiment. The optical stabilization system includes a sensor 252, such as an Intertial Measurement Unit (IMU), a controller 254 and risley prism 256. The sensor 252 detects movement of the system. In one example, an optical stabilization system is installed in an aircraft, and the sensor 252 detects movement of the system caused by the roll, pitch and yaw of the aircraft. The sensor 252 transmits data regarding the movement of the system to the controller 254. In one example, the sensor outputs the Euler angles describing the movement. The controller 254 uses the data to calculate how the risley prism 256 should be rotated and instructs the prisms 256 to rotate accordingly, as described in greater detail below with respect to FIG. 5. For example, if the aircraft rolls to one side, as shown in FIG. 1B, the sensor transmits the movement data, including the angle of roll, to the controller 254, and the controller 254 determines direction and distance of rotation of each risley prism 256 to correct for the angle of roll and maintain the optical field of view centered on the ground. According to one example, the prisms 256 can be rotated at a speed of up to about 6000 rotations per minute and can therefore compensate quickly for large and small aircraft movements.

In one embodiment, the risley prism 256 are configured as an addition to an imaging system, and have a separate controller from the controller 254 coupled to the sensor 252. In another embodiment, the risley prism 256 controller is integrated into the controller 254. The optical stabilization system may include a shifter 258 to translate instructions output by the controller 254 into the format expected by the risley prism controller. In one example, the shifter 258 is a RS-232 Shifter which translates the TTL format of data received from the sensor to the RS-232 format expected by the risley prism controller.

In one example, the optical stabilization system is coupled to a camera and installed in an aircraft. The controller 254 rotates the wedge prisms of the risley prism 256 in response to data from the sensor 252 to adjust the field of view of the camera. For instance, the controller 254 may be configured to rotate the wedge prisms of the risley prism 256 to keep the camera's line of sight centered straight down on the ground, aligned with the horizon, as discussed above.

In one embodiment, the optical stabilization system 250 includes a Global Positioning System (GPS) 260, which provides position coordinates. In various examples, the position coordinates provided by the GPS 260 may be used to identify image locations. Image locations may be used by mapping services, ground surveyors, or law enforcement.

As mentioned above, the risley prism in the optical stabilization system includes at least two wedge prisms rotated about a center axis. In one embodiment, the risley prism is mounted on bearings and a motor rotates the wedge prisms. FIG. 5 is a schematic diagram showing a side view of a system 200 for rotating first 202 and second 204 wedge prisms about an axis 206. The first wedge prism 202 is mounted on a first set of platforms 222a-222b, and the second wedge prism 204 is mounted on a second set of platforms 224a-224b. The first 222a-222b and second 224a-224b sets of platforms are coupled to bearings 208, motor rotors 210, motor stators 212 and rotary encoders 216, which are configured to rotate the wedge prisms 202 and 204 about the axis 206. The positions of the wedge prisms 202 and 204 determine the angle of the incoming beam of light 226 that is transmitted along axis 206. The bearings 208, motor rotors 210 and motor stators 212 are coupled to a housing 214, and the housing 214 may be installed in an imaging system including a camera. According to one aspect, the bearings 208, motor rotors 210, motor stators 212 and rotary encoders 216 rotate the wedge prisms 202 and 204 in response to data from a sensor as part of an optical stabilization system to adjust the field of view of a camera.

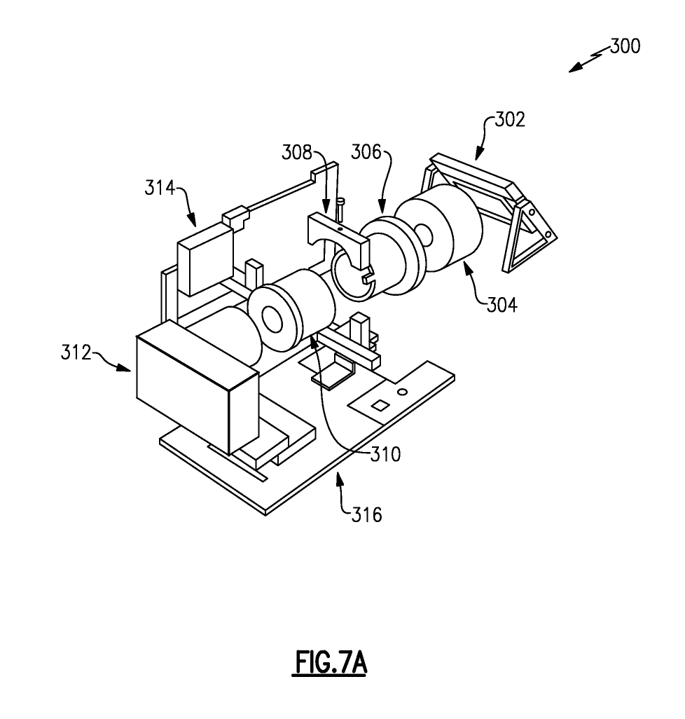

A system such as the system 200 of FIG. 5 may be used to rotate the prisms about a center axis and stabilize an optical image captured from an aircraft, as described in the method 280 of FIG. 6. At step 282, movement of the imaging system is sensed and the angles of the movement are calculated. The movement of the imaging system may be caused, for example, by aircraft movement. The angles of movement may be the Euler angles. At step 284, in response to the calculated angles of movement, a motor is directed to rotate two wedge prisms to change the angle of incoming light, as described above with respect to FIGS. 2A-2C, and adjust the field of view of a camera in the imaging system. At step 286, the incoming light is optically coupled through the wedge prisms to the camera.

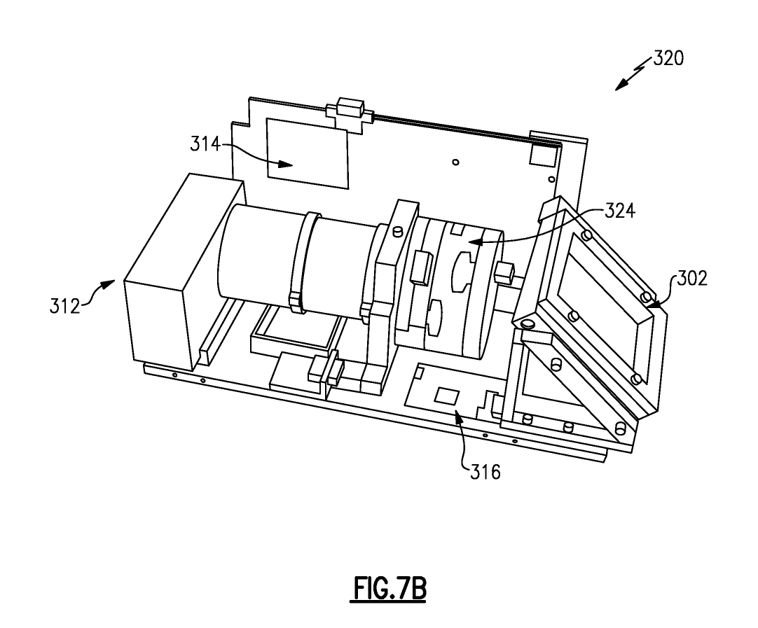

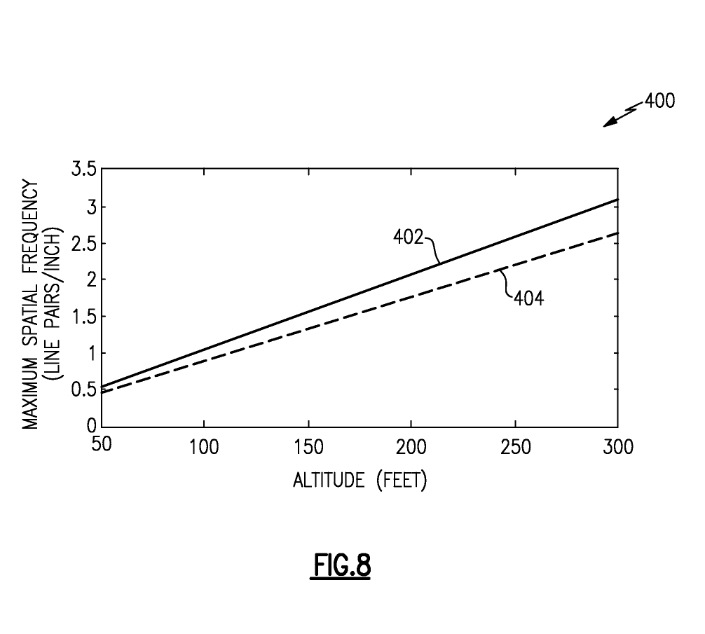

The method 280 of FIG. 6 may be implemented on an optical imaging system such as that shown in FIGS. 7A-7B. FIG. 7A is a schematic diagram showing the parts of an imaging system 300 including a one axis risley prism gimbal 304, according to an illustrative embodiment. The imaging system 300 also includes a fold minor 302, a hard mount 306, a hard sleeve 308, a soft mount 310, a camera 312, a controller 314 and a base plate 316. When the imaging system 300 is assembled, as shown in the illustrative embodiment in FIG. 7B, the hard mount 306 is inserted into the soft mount 310 and they are screwed together with the housing of the risley prism 324 using the hard sleeve 308. The one axis risley prism gimbal 304 shown in FIG, 7A is an exemplary diagram cylinder block while the one axis risley prism gimbal 324 in FIG. 7B shows a more detailed image of the exterior surface of a one axis risley prism gimbal. The soft mount 310 is coupled to housing of the lens of the camera 312. The system is mounted on the base plate 316, which may include another controller. As shown in FIG. 7A, the controller 314 is mounted on a side board, but in other embodiments, it may also be mounted on the base plate 316. In other embodiments, the controller 314 may be mounted anywhere on the optical stabilization system. The minor 302 is also mounted on the base plate.

According to one aspect, the fold minor 302 can be used to create a single adjustment to the field of view of the imaging system 300. In particular, the fold mirror 302 may redirect the field of view by about a ninety degree angle, such that when the imaging system 300 is mounted underneath an aircraft, the default field of view is the ground, perpendicular to the horizon when the camera 312 is directed forward, parallel with the horizon.

According to one aspect, the optical stabilization system described above may be used to direct a light source emitted from a device in the optical stabilization system. For example, the camera may be replaced with a light emitting device, such as a laser, to create digital measurement equipment. The single axis risley prism gimbal system may be used to steer the laser. In one example, the laser may be steered in response to data from an IMU, to maintain the laser's focus on the ground, in line with the horizon. In other examples, the laser may be focused in other directions.

According to another aspect, the optical stabilization system may be mounted on an aircraft without a fold mirror, with the line of sight of the camera perpendicular to the ground. According to one feature, this orientation would allow for three degrees of freedom in the correction of incoming light. In particular, the system can correct for yaw by rotating both prisms by the same amount so that the line of sight is rotated about the axis that is perpendicular to the ground by the same amount as the yaw. In one embodiment, the optical stabilization system may be configured with the fold minor positioned between the risley prism assembly and the imaging system to still allow for three degrees of freedom in the correction of incoming light. In This configuration the profile of the system is changed such that it would be L-shaped, with the risley prism assembly positioned perpendicular to the aircraft, the fold mirror positioned above the risley prism assembly to fold the incoming light beam by, for example, ninety degrees, and the imaging system positioned parallel to the aircraft. As will be appreciated by those skilled in the art, given the benefit of this disclosure, other configurations of the system with fold mirrors positioned at various angles also may be implemented.

The optical stabilization system described above has been tested in a laboratory, and the results were extrapolated to flight altitude as shown in the graphs in FIGS. 8-11. FIG. 8 is a graph 400 showing the resolution of the imaging system in line pairs per inch at various altitudes, according to one example. The graph 400 shows that the maximum spatial frequency that can be resolved increases with altitude. Thus, the system resolution decreases with altitude. The solid line 402 shows the resolution of the full imaging system, including the risley prism. The dashed line 404 shows the resolution using just a camera.

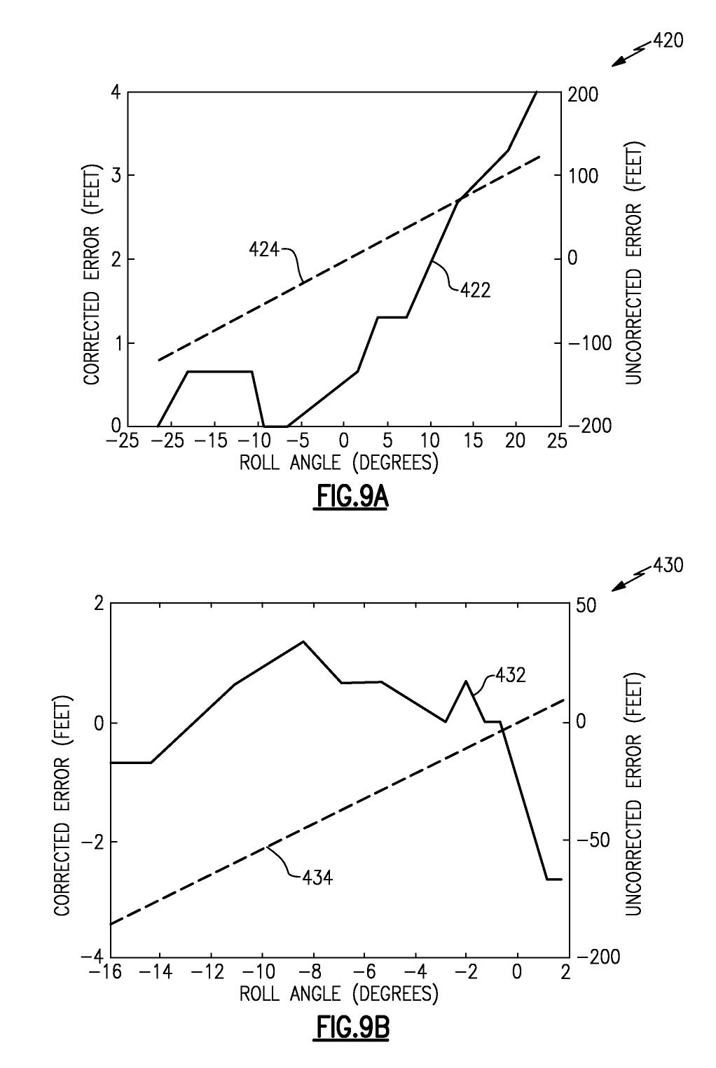

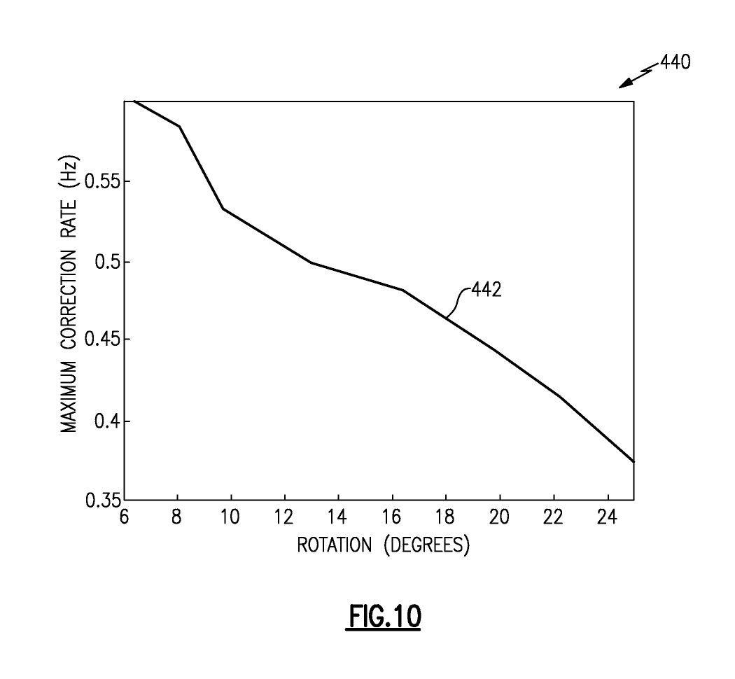

FIG. 9A is a graph 420 showing the error correction results at different roll angles, according to one example. The solid line 422 shows the corrected error in feet at various roll angles, with the error measurements given on the left-hand axis. While the corrected error results as measured in the laboratory tests and shown in FIG. 9A are somewhat erratic, a more fine-tuned calibration of the system will yield less erratic results, closer to zero error. The dashed line 424 shows the uncorrected error in feet at various roll angles, with the error measurements given on the right-hand axis. As shown in graph 420, the optical stabilization system decreases error by an order of magnitude at many roll angles. In one example, the optical stabilization system yields a 30-to-1 correction factor.

FIG. 9B is a graph 430 showing the error correction results at different pitch angles, according to an embodiment of the invention. The solid line 432 shows the corrected error in feet at various pitch angles, with the error measurements given on the left-hand axis. As described above with respect to FIG. 9A, while the corrected error results as measured in the laboratory tests and shown in FIG. 9B are somewhat erratic, a more fine-tuned calibration of the system will yield less erratic results, closer to zero error. The dashed line 434 shows the uncorrected error in feet at various pitch angles, with the error measurements given on the right-hand axis. As shown in graph 420, the optical stabilization system decreases error by an order of magnitude at many pitch angles. In one example, the optical stabilization system yields a 30-to-1 correction factor.

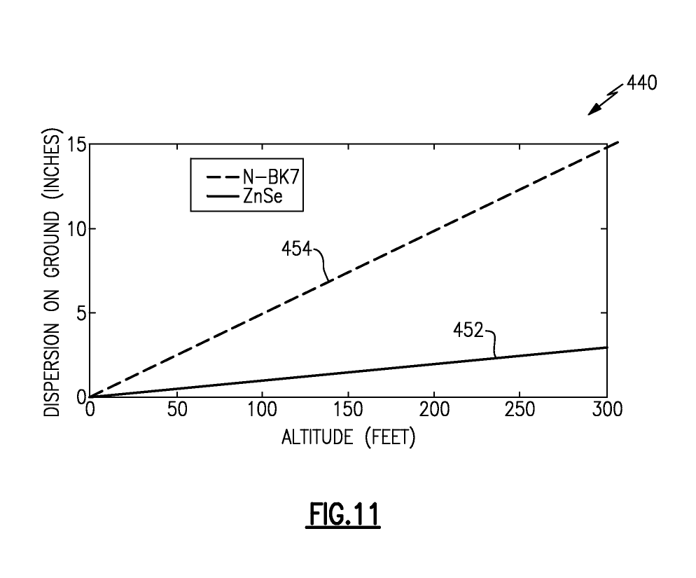

FIG. 10 is a graph 440 showing correction rate at various degrees of rotation at line 442. As shown in FIG. 10, rotation (for example, rolling or pitching) of an aircraft at large angle is corrected at a slower rate than aircraft rotation at a small angle. Thus, for example, referring to FIG. 10, if the platform (e.g. aircraft) is rolling or pitching at angles between about ±24 degrees, then the system can stabilize the image provided that the platform is not rolling or pitching at a rate greater than about 0.4 Hz. However, for smaller roll and/or pitch angles, for example, about ±7 degrees, the system may provide a stabilized image for movement rates of up to about 0.6 Hz, as shown in FIG. 10. While the tested system provided a correction rate of about 0.5 Hz over ±14 degrees of rotation, when the system may provide a correction rate of about 500 Hz when assembled using form factored boards and faster components.

FIG. 11 is graph 450 showing the prism dispersion comparison on the ground at various altitudes according to an embodiment of the invention. The graph 450 shows that the dispersion on the ground increases with altitude. For example, as shown in the graph 400, at 100 feet of altitude, use of the imaging system with the risley prism results in about five inches of dispersion, while at 300 feet of altitude, there is about 15 inches of dispersion. The graph 450 shows two different dispersion measurements for prisms constructed of two different materials. The solid line 452 represents dispersion measurements for prisms made of N-BK7, while the dashed line 454 shows the dispersion measurements for prisms made of Zinc selenide (ZnSe), over the visible spectrum.

In one example, as described above, the optical stabilization system may be installed in an aircraft, such as an airplane or helicopter. In other examples, the optical stabilization system may be installed in other vehicles, such as cars, trucks, motorcycles, snow mobiles, boats, submarines and jet skis. In further examples, the optical stabilization system may be installed in or on other objects such as helmets, bikes, backpacks, fanny packs, or paragliding equipment.

Accordingly, various aspects and embodiments are directed to a system and method of stabilizing an image captured by a moving imaging system using a risley prism including two or more wedge prisms. An optical stabilization system may be installed in an aircraft to correct for aircraft roll, pitch and yaw as well as general aircraft vibrations and maintain a camera's field of view focused on the ground, in line with the horizon. The single axis gimbal optical stabilization system having two wedge prisms as described above is more aerodynamic and substantially cheaper than conventional three axis gimbal optical stabilization systems.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An optical stabilization system, comprising:
a camera having a field of view and configured to receive incoming light to image a target;
a risley prism optically coupled to the camera and including a first wedge prism and a second wedge prism each configured to rotate about a first axis and configured to change an angle of incidence of the incoming light at the camera;
a sensor configured to sense movement of the optical stabilization system and to provide movement data; and
a motor coupled to the sensor and to the risley prism and configured to rotate at least one of the first and second wedge prisms about the first axis to change the angle of the incoming light in response to the movement data to maintain the target within the field of view of the camera.

2. The optical stabilization system of claim 1, further comprising a controller coupled to the sensor and to the motor and configured to receive the movement data from the sensor and, in response to the movement data, direct the motor to rotate the first and second wedge prisms.

3. The optical stabilization system of claim 2, wherein the controller is further configured to correlate images from the camera with the location coordinates of the optical stabilization system to determine locations on the earth corresponding to the images.

4. The optical stabilization system of claim 1, wherein the first and second wedge prisms are positioned between the incoming light and the camera.

5. The optical stabilization system of claim 1, further comprising a minor positioned adjacent to the first wedge prism configured to direct the incoming light into the first wedge prism.

6. The optical stabilization system of claim 1, wherein the sensor is an inertial measurement unit.

7. The optical stabilization system of claim 1, wherein the system is mounted on a mobile platform, and the sensor is configured to calculate angles of movement of the mobile platform with respect to the earth; and
wherein the movement data includes the angles of movement.

8. The optical stabilization system of claim 1, wherein the system is mounted on a mobile platform, and the sensor is configured to calculate the pitch, roll, and yaw of the mobile platform.

9. The optical stabilization system of claim 1, further comprising a global positioning unit coupled to the sensor configured to determine location coordinates of the optical stabilization system.

10. The system of claim 1, wherein the optical stabilization system is installed in an aircraft.

11. The system of claim 1, wherein the first and second wedge prisms together comprise a risley prism.

12. A method of stabilizing a field of view of an optical imaging system mounted on an aircraft, the method comprising:
directing a field of view of the optical imaging system toward a ground-based target;
detecting motion of the aircraft and providing corresponding angular movement data; and
refracting incident light on optical imaging system by rotating at least one of a pair wedge prisms responsive to the angular movement data to maintain the target within the field of view of the optical imaging system.

13. The method of claim 12, wherein detecting motion includes sensing pitch, roll and yaw of the aircraft.

14. The method of claim 12, further comprising
determining location coordinates of the optical imaging system with a global positioning unit; and
correlating images captured with the optical imaging system with the location coordinates.

15. The method of claim 12, wherein rotating the at least one of the pair of wedge prisms includes actuating a motor coupled to the pair of wedge prisms to rotate the prism.
